(19) United States
(12) Patent Application Publication
(10) Pub. No.: US 2012/0153747 A1
(43) Pub. Date: Jun. 21, 2012

(54) USB CHARGER, ITS SWITCH CONTROL SYSTEM AND METHOD, AND A USB INTERFACE CHARGER FOR A LAPTOP

(75) Inventors: Yuancheng Lu, Shanghai (CN); Weibi Hong, Shanghai (CN)

(73) Assignee: New Focus Lighting & Power Technology (Shanghai) Co. Ltd., Shanghai (CN)

(21) Appl. No.: 13/059,627

(22) PCT Filed: Nov. 26, 2009
(86) PCT No.: PCT/CN09/01335

§ 371 Date: Feb. 17, 2011

(30) Foreign Application Priority Data
Sep. 11, 2009 (CN) 200910195582.2

(51) Int. Cl. H02J 7/00

(52) U.S. Cl. 307/131; 307/125

(57) ABSTRACT

The present invention discloses a switch control system and its method for a USB charger, wherein the switch control system controls the on-off status of the charging circuit according to whether a charging load is connected or not. The switch control system comprises a first switch and an on-off control unit of the first switch. The first switch connects to a charging power and a converter; the on-off control unit of the first switch connects to the USB output interface and the first switch to control the on-off status of the first switch according to whether the charging load is connected or not. The switch control system and the method for the USB charger disclosed by the present invention realize automatic switching on and off of the USB operating circuit when a load is connected to or removed from the USB output interface.

### BACKGROUND OF THE INVENTION

1. Technical Field

The present invention, pertaining to the technical field of universal serial bus (USB), relates to a USB charger, and more specifically, to a USB interface charger for a laptop. Moreover, the present invention further relates to a USB charger switch control system and method.

2. Description of Related Art

As a data transmission interface for a laptop, USB is often used as a 5V output USB charging interface, or as a 5V output interface for other small appliances. However, the USB 5V output for a laptop is only available when the laptop is activated. To use the USB 5V output after the laptop is turned off, the USB must be provided with a switch. Otherwise, the USB 5V output circuit will keep consuming electricity until the power of the laptop cell panel is used up. Even if a switch is installed, the user is prone to forget to switch off the USB output after use; as a result, the power of the laptop cell panel is used up after a long time.

Since no signal in the four-core line of the USB interface can be utilized, it becomes impossible to automatically switch on the USB circuit after a USB output load is connected and automatically switch off the USB circuit after the USB output load is removed.

CN 200510200489.8 discloses a USB charger, comprising a wire rotator with a limit button and an adaptor inside the upper and lower frames, wherein the wire rotator includes a movable rotary disk, an electrical line wound around one surface of the disk, a movable contact on another surface of the disk, and a return spring inside the lower round groove of the rotary disc; the adaptor has a fixed contact electrically contacted with the movable contact of the rotary disc; the coiling inner end of the electrical line is electrically connected with the adaptor via the movable contact on the disk; and the power converter for transforming the USB input power to the output power fit for the device to be charged is further included in the upper and lower frames.

CN 200720054281.4 relates to a multifunctional USB charger. Its essential technical features lie in: comprising a USB input plug, which can be connected to an external equipment to receive power from the external equipment; a booster circuit connected with the USB input plug, which allows the transformation of a low power received to a high power for output; an output plug connected with the booster circuit, which can transfer the high power from the booster circuit to an external equipment for charging; a battery connected between the USB input plug and the booster circuit, which can receive the power from the external equipment via the USB input plug, and can also charge up the external equipment via the booster circuit and the output plug.

The two USB chargers described above both fail to automatically switch on the USB circuit when the USB output load is connected and automatically switch off the USB circuit when the USB output load is removed.

### SUMMARY OF THE INVENTION

The technical problem to be solved by the present invention is to provide a USB charger which can realize automatic switching on and off of a USB operating circuit when a load is connected to or removed from the USB output. The aforesaid USB charger can be a USB interface charger for a laptop.

Meanwhile, the present invention further provides a switch control system for a USB charger to realize automatic switching on and off of the USB operating circuit when a USB output load is connected or removed.

Furthermore, the present invention also provides a switch control method for a USB charger to realize automatic switching on and off of the USB operating circuit when a USB output load is connected or removed.

To solve the aforesaid technical problem, the present invention adopts the following technical solution:

A switch control system of a USB charger, characterized in that the system controls the on-off status of a charging circuit according to whether a charging load is connected or not, the switch control system comprising:

a first switch, connecting to a charging power and a converter;

an on-off control unit of the first switch, connecting to a USB output interface and the first switch to control the on-off status of the first switch according to whether a charging load is connected to the USB output interface or not.

As a preferred solution of the present invention, the switch control system further comprises a current sensing unit and a microcurrent supply unit; wherein a charging power voltage is inputted into the converter via the first switch to generate a second voltage, and then the second voltage is outputted at the USB output interface through the current sensing unit; when no load is connected, the current sensing unit outputs no signal; at this time, the switch control system releases the first switch to switch off the circuit, and the charging power only supplies microcurrent to the current sensing unit via the microcurrent supply unit; when a load is connected, a current sensing signal enables the switch control circuit to close the first switch to activate the DC-DC converter and generates a USB 5V output.

As a preferred solution of the present invention, the first switch is a transistor T1 with its base connecting to the on-off control unit of the first switch.

As a preferred solution of the present invention, the on-off control unit of the first switch comprises a second switch which is automatically switched on or off according to whether the charging load is connected or not; wherein, when a load is connected, the second switch is switched on; when no load is connected, the second switch is switched off.

As a preferred solution of the present invention, the on-off control unit of the first switch comprises:

a transistor T3, whose base is connected to the USB output interface;

a transistor T2, whose base is connected to the transistor T3;

a transistor T4, whose base is connected to the transistor T3;

a transistor T5, whose base is connected to ground via a voltage stabilizing circuit; or the transistor T5 is replaced by a MOS transistor or a Darlington transistor.

As a preferred solution of the present invention, the first switch is a transistor T1; wherein the transistors T1 and T3 are PNP transistors, the transistors T2, T4, and T5 are NPN transistors; an emitter of the transistor T1 is connected to the charging power, a collector is connected to the converter, a base is connected to a collector of the transistor T2; an emitter of the transistor T2 is grounded, the base is connected to a collector of the transistor T3; an emitter of the transistor T3 is connected to an output of the converter, the collector is connected to the base of the transistor T2 and the base of the transistor T4; an emitter of the transistor T4 is grounded, a collector is connected to the base of the transistor T5; a collector of the transistor T5 is connected to the charging power, an emitter is connected to the output of the converter; a resistor R6, one end of the resistor R6 is connected to the collector of the transistor T5, another end of the resistor R6 is connected to the base of the transistor T5.

As a preferred solution of the present invention, a diode D1 is connected between the output of the converter and the USB output interface; and the transistor T5 is selected from voltage-driven or low current-driven apparatus

A USB charger, comprising a charging power and a switch control system, wherein the switch control system controls the on-off status of a charging circuit according to whether a charging load is connected or not; the switch control system comprises: a first switch, connecting to the charging power and a converter; an on-off control unit of the first switch, connecting to a USB output interface and the first switch to control the on-off status of the first switch according to whether a charging load is connected to the USB output interface or not.

As a preferred solution of the present invention, the first switch is a transistor T1 with its base connecting to the on-off control unit of the first switch, and the on-off control unit of the first switch comprises:

a transistor T3, whose base is connected to the USB output interface;

a transistor T2, whose base is connected to the transistor T3;

a transistor T4, whose base is connected to the transistor T3;

a transistor T5, whose base is connected to ground via a voltage stabilizing circuit; or the transistor T5 is replaced by a MOS transistor or a Darlington transistor.

Furthermore, the first switch is a transistor T1; wherein the transistors T1 and T3 are PNP transistors, and the transistors T2, T4, and T5 are NPN transistors; an emitter of the transistor T1 is connected to the charging power, a collector is connected to the converter, a base is connected to a collector of the transistor T2; an emitter of the transistor T2 is grounded, the base is connected to a collector of the transistor T3; an emitter of the transistor T3 is connected to an output of the converter, the collector is connected to the base of the transistor T2 and the base of the transistor T4; an emitter of the transistor T4 is grounded, a collector is connected to the base of the transistor T5; a collector of the transistor T5 is connected to the charging power, an emitter is connected to the output of the converter; a resistor R6, one end of the resistor R6 is connected to the collector of the transistor T5, another end of the resistor R6 is connected to the base of the transistor T5.

A switch control method of a USB charger, the method controls the on-off status of a charging circuit according to whether a charging load is connected or not; provide a first switch, which connects to a charging power of the USB charger and a converter; provide an on-off control unit of the first switch, which connects to the USB output interface and the first switch to control the on-off status of the first switch according to whether a charging load is connected to the USB output interface or not.

A USB interface charger for a laptop, which comprises a battery and a charging switch control system, wherein the charging switch control system controls the on-off status of a charging circuit according to whether a charging load is connected or not; the charging switch control system comprises:

a DC-DC converter;

a first switch, connects to the battery and the DC-DC converter;

an on-off control unit of the first switch, connects to a USB output interface and the first switch to control the on-off status of the first switch according to whether a charging load is connected to the USB output interface or not.

As a preferred solution of the present invention, the charging switch control system further comprises a current sensing unit and a microcurrent supply unit; wherein a battery voltage is inputted into the DC-DC converter via the first switch to generate a second voltage, and then the second voltage is outputted at the USB output interface through the current sensing unit; when no load is connected, the current sensing unit outputs no signal; at this time, the switch control system releases the first switch to switch off the circuit, and the charging power only supplies microcurrent to the current sensing unit via the microcurrent supply unit; when a load is connected, a current sensing signal enables the switch control circuit to close the first switch to activate the DC-DC converter and generates a USB 5V output.

As a preferred solution of the present invention, the first switch is a transistor T1 with its base connecting to the on-off control unit of the first switch;

the on-off control unit of the first switch comprises:

a transistor T3, whose base is connected to the USB output interface;

a transistor T2, whose base is connected to the transistor T3;

a transistor T4, whose base is connected to the transistor T3;

a transistor T5, whose base is grounded via a voltage stabilizing circuit; or the transistor T5 is replaced by a MOS transistor or a Darlington transistor.

Furthermore, the first switch is a transistor T1, the transistors T1 and T3 are PNP transistors, the transistors T2, T4, and T5 are NPN transistors; an emitter of the transistor T1 is connected to a battery, a collector is connected to the converter, a base is connected to a collector of the transistor T2; an emitter of the transistor T2 is grounded, the base is connected to a collector of the transistor T3; an emitter of the transistor T3 is connected to an output of the converter, the collector is connected to the base of the transistor T2 and the base of the transistor T4; an emitter of the transistor T4 is grounded, a collector is connected to the base of the transistor T5; a collector of the transistor T5 is connected to the battery, an emitter is connected to the output of the converter; a resistor R6, one end of the resistor R6 is connected to the collector of the transistor T5, another end of the resistor R6 is connected to the base of the transistor T5.

The advantageous effect of the present invention is that: the switch control system and method for a USB charger of the present invention can automatically switch on and switch off the USB operating circuit when a load is connected to or removed from the USB output. If the user forgets to switch off the USB operating circuit after using the USB output, the switch system will automatically switch off the USB operating circuit so as to effectively save power energy.

### BRIEF DESCRIPTION OF THE DRAWINGS

FIG. 1 is a schematic view of the modules of the USB interface charger for a laptop according to the present invention.

FIG. 2 is a circuit diagram of the switch control system of the USB charger according to the present invention.

### DESCRIPTION OF THE PREFERRED EMBODIMENTS

The present invention is detailed in combination with the drawings and the preferred embodiments below.

### Embodiment 1

The present invention discloses a USB charger and its switch control system. The switch control system controls the on-off status of the charging circuit according to whether a charging load is connected or not, in this way, automatically switching on and off the USB operating circuit when a load is connected or disconnected to the USB output.

The switch control system comprises a first switch and an on-off control unit of the first switch. The first switch is connected to a charging power and a converter. The on-off control unit of the first switch is connected to the USB output interface and the first switch to control the on-off status of the first switch according to whether a charging load is connected or not. The on-off control unit of the first switch can comprise a second switch which is automatically switched on or off according to whether the USB output interface is connected with a charging load or not. When a load is connected, the second switch is switched on; when no load is connected, the second switch is switched off.

As shown in FIG. 2, in this embodiment, the first switch is a transistor T1. The on-off control unit of the first switch comprises a transistor T2, a transistor T3, a transistor T4 and a transistor T5. The transistors T1, T3 are PNP transistors, while the transistors T2, T4, T5 are NPN transistors. The emitter of the transistor T1 is connected to the charging power; the collector of T1 is connected to the converter; the base of T1 is connected to the collector of the transistor T2. The emitter of the transistor T2 is connected to the ground; the base of T2 is connected to the collector of the transistor T3. The emitter of the transistor T3 is connected to the output of the converter, the collector of T3 is connected to the base of the transistor T2 and the base of the transistor T4. The emitter of the transistor T4 is connected to the ground; the collector of T4 is connected to the base of the transistor T5. The collector of the transistor T5 is connected to the charging power, the emitter of T5 is connected to the output of the converter and the emitter of the transistor T3. A resistor R6 is provided; one end of the resistor R6 is connected to the collector of the transistor T5; another end of R6 is connected to the base of the transistor T5. Furthermore, the base of the transistor T5 is connected to the ground via a voltage stabilizing diode Z1. The transistor T5 can be selected from voltage-driven or low current-driven apparatus. For instance, the transistor T5 can be replaced by a MOS transistor or a Darlington transistor.

A diode D1 is connected between the output of the converter and the USB output interface. As shown in FIG. 2, resistors R2, R4, R5 are respectively connected to the bases of the transistors T1, T2, T4. Meanwhile, a resistor R3 is provided; one end of the resistor R3 is connected to the base of the transistor T1; another end of R3 is connected to the emitter of the transistors T1.

The present invention further discloses the switch control method of the aforesaid USB charger. In this method, the on-off status of the charging circuit is controlled according to whether a charging load is connected or not. The method comprises the following steps:

Provide a first switch, which is connected to a charging power of the USB charger and the converter. In this embodiment, the first switch is a transistor T1.

Provide an on-off control unit of the first switch, which is connected to the USB output interface and the first switch to control the on-off status of the first switch according to whether a charging load is connected or not. The on-off control unit of the first switch can comprise a second switch which is automatically switched on or off according to whether a charging load is connected or not. When a load is connected, the second switch is switched on; when no load is connected, the second switch is switched off. As shown in FIG. 2, in this embodiment, the on-off control unit of the first switch mainly comprises a transistor T2, a transistor T3, a transistor T4 and a transistor T5.

The control principles of the switch control system of the present invention:

As shown in FIG. 2, when no load is connected to the USB output, the base current passing through the transistor T3 is zero and the transistor T3 is turned off, so that the base current of the transistor T2 is also zero and the transistor T2 is also turned off. In this way, the base current of the transistor T1 is zero and the transistor T1 is turned off. Therefore, the 5.6V converter has no power supply and does not work. Since the transistor T3 is turned off and the transistor T4 is also turned off, the transistor T5 is turned on by the driven of R6; the charging voltage Vin provides 5V power to the load via T5; but no load exists at this time, so there is no current. T5 can be selected from voltage-driven or low current-driven apparatus, such as a MOS transistor or a Darlington transistor. In this way, the resistor R6 can be designed to have a large resistance value, so that nearly no power is consumed at this time. Since the current supplied by the transistor T5 will not flow back to the 5.6V converter, the whole circuit consumes almost no power.

When a USB output load is connected, there is current passing through the base of the transistor T3 and the transistor T3 is turned on, thus the transistors T2, T1, T4 are all turned on. The 5.6V converter works. At this time, the transistor T5 is turned off due to the conduction of the transistor T4. The 5V output of the USB is supplied by the 5.6V converter in an efficient way.

To sum up, the switch control system and method for a USB charger disclosed by the present invention realizes automatic switching on and off of the USB operating circuit when a load is connected to or removed from the USB output. If the user forgets to switch off the USB operating circuit after using the USB output, the system can automatically switch off the USB operating circuit so as to effectively save power energy.

### Embodiment 2

The difference between this embodiment and Embodiment 1 is that, in this embodiment, the transistors T1, T2, T3, T4 and T5 can be replaced by MOS transistors, Darlington transistors, or other elements that can be used as a switch.

### Embodiment 3

This embodiment further describes the present invention by describing the use of the USB charger of the present invention in a laptop. This embodiment introduces a USB 5V output circuit (namely the USB charger according to the present invention) special for a laptop. This output circuit can switch off the circuit generating a USB DC-DC 5V output when there is no load, so that the power consumption is only at a microammeter level; where there is a load (even as low as microammeter), the USB output can be automatically restored.

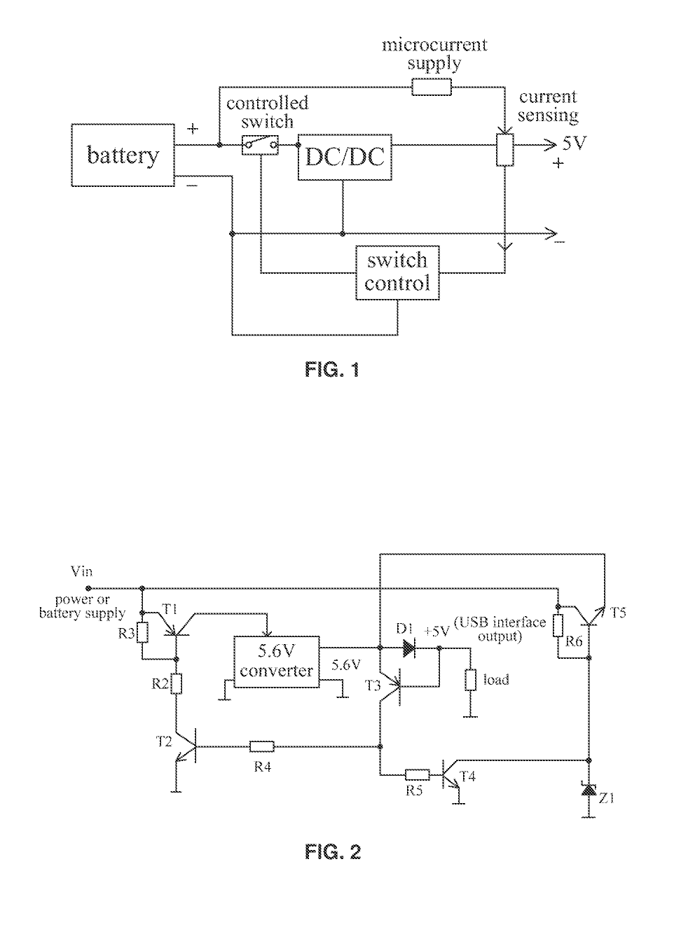

As shown in FIG. 1, the USB interface charger for a laptop in this embodiment comprises a battery and a charging switch control system. The charging switch control system controls the on-off status of the charging circuit according to whether a charging load is connected or not. The charging switch control system comprises a first switch (controlled switch), an on-off control unit of the first switch (switch control unit), a DC-DC converter, a current sensing unit and a microcurrent supply unit. The first switch is connected to the battery and the DC-DC converter. The on-off control unit of the first switch is connected to the USB output interface and the first switch to control the on-off status of the first switch according to whether or not a charging load is connected to the USB output interface.

FIG. 2 shows a detailed embodiment of the abovementioned circuit. The realization process and the operation principles are the same as described in Embodiment 1.

The working process of the USB interface charger for a laptop according to the present invention is mainly as follows:

As shown in FIG. 1, a battery voltage of higher than 6V is inputted into the DC-DC converter via the controlled switch to get a 5V (or slightly higher than 5V) voltage, and then output the 5V voltage at the USB output interface through the current sensing unit.

When no load is connected, no output signal is provided by the current sensing unit. At this time, the charging switch control system releases the controlled switch to switch off the circuit; the battery only supplies microcurrent to the current sensing unit via the microcurrent supply unit.

When a load is connected, the current sensing signal enables the switch control circuit to close the controlled switch to activate the DC-DC converter, so that the USB 5V output is restored.

The current sensing unit of the aforesaid circuit can also be disposed at the negative output line of the 5V voltage.

Moreover, the USB charger and the switch control system of the present invention can be used for other similar appliances with USB interface in addition to a laptop.

To sum up, the present invention provides a practical circuit solution, through which the USB operating circuit can be automatically switched on or off when a load is connected to or removed from the USB output of an appliance such as a laptop.

The description and application of the present invention herein is for illustrative purposes only. They do not constitute restriction to the scope of the present invention within the aforesaid embodiments. To make deformation and change to the embodiments disclosed herein acceptable. It is generally known to those skilled in this art to adopt substituted embodiments or equivalent parts. The technicians in this art shall be clear that the present invention can be realized by means of other forms, structures, arrangements, proportions, and other assemblies, materials and parts without deviating from the spirit or essential characteristics of the present invention. The embodiments disclosed herein may be deformed and modified within the protection scope of the present invention.

1. A switch control system of a USB charger, characterized in that, the system controls on-off status of a charging circuit according to whether a charging load is connected or not, the switch control system comprising:
a first switch, connecting to a charging power and a converter;
an on-off control unit of the first switch, connecting to a USB output interface and the first switch to control the on-off status of the first switch according to whether the charging load is connected to the USB output interface or not.

2. The switch control system of a USB charger according to claim 1, characterized in that:
the switch control system further comprises a current sensing unit and a microcurrent supply unit; wherein
a charging power voltage is inputted into the converter via the first switch to generate a second voltage, and then the second voltage is outputted at the USB output interface through the current sensing unit;
when no load is connected, the current sensing unit outputs no signal; at this time, the switch control system releases the first switch to switch off the circuit, and the charging power only supplies microcurrent to the current sensing unit via the microcurrent supply unit;
when a load is connected, a current sensing signal enables the switch control circuit to close the first switch to activate the converter and generates a USB 5V output.

3. The switch control system of a USB charger according to claim 1, characterized in that:
the first switch is a transistor T1 with its base connecting to the on-off control unit of the first switch.

4. The switch control system of a USB charger according to claim 1, characterized in that:
the on-off control unit of the first switch comprises a second switch which is automatically switched on or off according to whether the charging load is connected or not; wherein, when a load is connected, the second switch is switched on; when no load is connected, the second switch is switched off.

5. The switch control system of a USB charger according to claim 1, characterized in that:
the on-off control unit of the first switch comprises:
a transistor T3, whose base being connected to the USB output interface;
a transistor T2, whose base being connected to the transistor T3;
a transistor T4, whose base being connected to the transistor T3;
a transistor T5, whose base being connected to ground via a voltage stabilizing circuit; or the transistor T5 being replaced by a MOS transistor or a Darlington transistor.

6. The switch control system of a USB charger according to claim 5, characterized in that:
the first switch is a transistor T1; wherein
the transistors T1 and T3 are PNP transistors, the transistors T2, T4, and T5 are NPN transistors;
an emitter of the transistor T1 being connected to the charging power, a collector being connected to the converter, a base being connected to a collector of the transistor T2;
an emitter of the transistor T2 being grounded, the base being connected to a collector of the transistor T3;
an emitter of the transistor T3 being connected to an output of the converter, the collector being connected to the base of the transistor T2 and the base of the transistor T4;
an emitter of the transistor T4 being grounded, a collector being connected to the base of the transistor T5;
a collector of the transistor T5 being connected to the charging power, an emitter being connected to the output of the converter; a resistor R6, one end of the resistor R6 being connected to the collector of the transistor T5, another end of the resistor R6 being connected to the base of the transistor T5.

7. The switch control system of a USB charger according to claim 5, characterized in that:
a diode D1 is connected between the output of the converter and the USB output interface; and
the transistor T5 is selected from voltage-driven or low current-driven apparatus.

8. A USB charger, characterized in that: comprising a charging power and a switch control system, wherein the switch control system controls on-off status of a charging circuit according to whether a charging load is connected or not, the switch control system comprising:
a first switch, connecting to the charging power and a converter;
an on-off control unit of the first switch, connecting to a USB output interface and the first switch to control the on-off status of the first switch according to whether the charging load is connected to the USB output interface or not.

9. The USB charger according to claim 8, characterized in that:
the first switch is a transistor T1 with its base connecting to the on-off control unit of the first switch,
the on-off control unit of the first switch comprising:
a transistor T3, whose base being connected to the USB output interface;
a transistor T2, whose base being connected to the transistor T3;
a transistor T4, whose base being connected to the transistor T3;
a transistor T5, whose base being connected to ground via a voltage stabilizing circuit; or the transistor T5 being replaced by a MOS transistor or a Darlington transistor.

10. The USB charger according to claim 9, characterized in that:
the first switch is a transistor T1; wherein
the transistors T1 and T3 are PNP transistors, and the transistors T2, T4, and T5 are NPN transistors;
an emitter of the transistor T1 being connected to the charging power, a collector being connected to the converter, a base being connected to a collector of the transistor T2;
an emitter of the transistor T2 being grounded, the base being connected to a collector of the transistor T3;
an emitter of the transistor T3 being connected to an output of the converter, the collector being connected to the base of the transistor T2 and the base of the transistor T4;
an emitter of the transistor T4 being grounded, a collector being connected to the base of the transistor T5;
a collector of the transistor T5 being connected to the charging power, an emitter being connected to the output of the converter; a resistor R6, one end of the resistor R6 being connected to the collector of the transistor T5, another end of the resistor R6 being connected to the base of the transistor T5.

11. (canceled)

12. A USB interface charger for a laptop, characterized in that, comprising a battery and a charging switch control system, wherein the charging switch control system controls on-off status of a charging circuit according to whether a charging load is connected or not; the charging switch control system comprising:
a DC-DC converter;
a first switch, connecting to the battery and the DC-DC converter;
an on-off control unit of the first switch, connecting to a USB output interface and the first switch to control the on-off status of the first switch according to whether the charging load is connected to the USB output interface or not.

13. The USB interface charger for a laptop according to claim 12, characterized in that:
the charging switch control system further comprises a current sensing unit and a microcurrent supply unit; wherein
a battery voltage is inputted into the DC-DC converter via the first switch to generate a second voltage, and then the second voltage is outputted at the USB output interface through the current sensing unit;
when no load is connected, the current sensing unit outputs no signal; at this time, the switch control system releases the first switch to switch off the circuit, and a battery only supplies microcurrent to the current sensing unit via the microcurrent supply unit;
when a load is connected, a current sensing signal enables the switch control circuit to close the first switch to activate the DC-DC converter and generates a USB 5V output.

14. The USB interface charger for a laptop according to claim 12, characterized in that:
the first switch is a transistor T1 with its base connecting to the on-off control unit of the first switch;
the on-off control unit of the first switch comprising:
a transistor T3, whose base being connected to the USB output interface;
a transistor T2, whose base being connected to the transistor T3;
a transistor T4, whose base being connected to the transistor T3;
a transistor T5, whose base being grounded via a voltage stabilizing circuit; or the transistor T5 being replaced by a MOS transistor or a Darlington transistor.

15. The USB interface charger for a laptop according to claim 13, characterized in that:
the transistors T1 and T3 are PNP transistors, the transistors T2, T4, and T5 are NPN transistors;
an emitter of the transistor T1 being connected to the battery, a collector being connected to the converter, a base being connected to a collector of the transistor T2;
an emitter of the transistor T2 being grounded, the base being connected to a collector of the transistor T3;
an emitter of the transistor T3 being connected to an output of the converter, the collector being connected to the base of the transistor T2 and the base of the transistor T4;
an emitter of the transistor T4 being grounded, a collector being connected to the base of the transistor T5;
a collector of the transistor T5 being connected to the battery, an emitter being connected to the output of the converter; a resistor R6, one end of the resistor R6 being connected to the collector of the transistor T5, another end of the resistor R6 being connected to the base of the transistor T5.
